(19) United States
(12) Patent Application Publication
(10) Pub. No.: US 2003/0158062 A1
(43) Pub. Date: Aug. 21, 2003

(54) Compositions useful for removal of paint residues

(76) Inventor: Neil R. Wilson, Lake Orion, MI (US)

Correspondence Address: HENKEL CORPORATION, 2500 RENAISSANCE BLVD, STE 200, GULPH MILLS, PA, 19406, US

(21) Appl. No.: 10/338,212

(22) Filed: Jan. 8, 2003

Related U.S. Application Data
(63) Continuation-in-part of application No. 10/025,729, filed on Dec. 18, 2001.

(51) Int. Cl. C11D 1/00

(52) U.S. Cl. 510/201; 510/203

(57) ABSTRACT

Compositions containing an aromatic naptha fraction or blend having a flash point of at least about 100 degrees F., at least one alcohol having one to five carbon atoms, and at least one auxiliary solvent such as an ester or ketone are effective in removing paint residues from surfaces.

### CROSS-REFERENCE TO RELATED APPLICATION

This application is a continuation-in-part of application Ser. No. 10/025,729, filed Dec. 18, 2001, incorporated herein by reference in its entirety.

### FIELD OF THE INVENTION

This invention relates to methods and compositions for cleaning uncured paint deposits and residues from equipment employed for painting articles of manufacture following fabricating operations. More specifically, in one aspect, this invention relates to blends of solvents useful in cleaning the interiors, surfaces or other sections of paint delivery lines, pumps, sprayers, tanks and the like employed in the painting of automobiles, trucks, or appliances of unwanted remaining paints (especially solvent borne paints) in preparation for the changeover from one paint system to another. In another aspect, this invention relates more specifically to the blended compositions that are prepared according to this invention.

### BACKGROUND OF THE INVENTION

Numerous compositions and blends are available for a wide variety of flushing and cleaning operations to remove uncured paint deposits from paint delivery tanks, pumps, sprayers, and lines. Various mixes and blends of components have been employed for cleaning paint deposits from such equipment including alkyl acetates, aromatics, ketones, and mono- and polyhydric alcohols. U.S. Pat. No. 5,759,975 describes a paint cleaning system which combines a wide range of aromatic solvents and napthas with alcohols and glycolic acids. Acetates and ketones are optionally employed. U.S. Pat. No. 5,454,985 describes paint stripping compositions comprising water, benzyl alcohols, sulfonates and organic acids. U.S. Pat. No. 5,035,829 describes paint removing compositions comprising organic carboxylic acids, N-methyl-2-pyrolidone, and an alkylene glycol ether.

While a number of different paint removal or paint purge compositions are known which are satisfactory with respect to either Hazardous Air Pollutant content, resistivity, flash point or low cost, unfortunately none of these formulations are satisfactory in all such respects.

### BRIEF DESCRIPTION OF THE INVENTION

Selected solvent components may be blended to provide a composition of low Hazardous Air Pollutant (HAP) content with a flash point (as measured by the ASTM Tag Closed Cup method) of at least about 60 degrees F. (16 degrees C.) and a resistivity of about 0.1 Megaohms (Mohms) or higher. The composition is relatively low cost to produce, yet furnishes excellent cleaning performance in the loosening and removal of uncured paint residues and the like from substrate surfaces..

The compositions of the present invention may be prepared by selecting and blending together aromatic naphthas having a flash point of at least about 100 degrees F. (38 degrees C.) with alcohols having a flash point less than about 59 degrees F. (15 degrees C.) so that the resulting blend has a flash point of at least about 60 degrees F. (16 degrees C.) and a resistivity of at least about 0.1 Mohms. The alcohol-aromatic naptha combination is highly effective in removing solvent borne paint residues while having a flash point above about 60 degrees F. (16 degrees C.). Surprisingly, this combination reduces the need to incorporate relatively large amounts of expensive auxiliary solvents such as esters and ketones in order to achieve satisfactory paint removal performance. That is, one unexpected advantage of this invention is that paint residues may be quickly removed or purged from paint delivery equipment using compositions containing relatively low concentrations of ester and/or ketone solvents. The preferred compositions and methods of the present invention are highly effective for purging dried or partially dried residues of solvent borne paint systems such as pigmented resins of epoxies, polyethers, polyacrylates, polyurethanes, polyesters, melamines and the like which are typically dispersed or dissolved in organic solvents.

In general, it is desirable to minimize the content of Hazardous Air Pollutants (HAP) in paint cleaning compositions in an effort to meet Federal Air Pollution Standards as set forth in Section 112 of Title 42 USC Section 7412, where Hazardous Air Pollutants are listed in Subsection (b). In the formulations of this invention it is preferred to maintain an HAP content less than about 4.5% by weight, as this level of HAP is commonly specified as the maximum by companies using solvent-based paint and coating removal compositions in their painting operations. However, in general, depending on the application, the formulations of the present invention can contain up to about 25% HAP by weight.

While prior art methods such as those described in U.S. Pat. No. 5,759,975 employ acidic components such as glycolic acid to effect a “deep cleaning” of paint encrusted systems, the blends of the present invention are preferably neutral (neither basic nor acidic) and are designed mainly for purging uncured paint residues from paint lines and vessels. Hence, acids or bases are preferably absent from the formulations. Accordingly, corrosion inhibitors are not required in most applications. Thickeners are preferably not present since they tend to inhibit or interfere with flushing operations.

### DETAILED DESCRIPTION OF THE INVENTION

More specifically, in accordance with this invention, a low HAP composition useful for purging and removing solvent borne paint residues from paint lines and the like is provided which consists essentially of: (a) from about 40 to about 90% by weight, based on the total weight of the composition, of an aromatic naphtha fraction or blend having a flash point of at least about 100 degrees F. (38 degrees C.), (b) from about 10 to about 30% by weight, based on the total weight of the composition, of one or more C₁ to C₅ alcohols having a flash point less than about 59 degrees F. (15 degrees C.), and (c) from about 1 to about 30% by weight, based on the total weight of the composition, of one or more auxiliary solvents. The composition has a flash point of at least about 60 degrees F. (16 degrees C.) and a solvent resistivity of at least about 0.1 Mohms. Preferably, the composition is free of acids or bases and has a substantially neutral pH that is most preferably between about 6.5 to about 7.5.

The aromatic naphtha fractions or blends which are useful in the present invention are derived from distillate fractions having a flash point of at least about 100 degrees F. (38 degrees C.). Alternatively, they may be blends of aromatic hydrocarbons (e.g., benzene, toluene, xylene, and higher homologs) which are mixed in proportions effective to achieve the desired flash point. Illustrative aromatic naptha fractions or blends are sold by ExxonMobil Chemical as Aromatic 100 Fluid, SC-100, Aromatic 150 Fluid, SC-150, Naphthalene Depleted Aromatic 150 Fluid, and Aromatic 200 Fluid.

The aromatic naphtha blend or fraction is more preferably present in the overall paint cleaning composition in an amount between about 50 to about 80%, and most preferably between about 55 and about 65%, by weight of the total weight of the composition. The term flash point as employed herein is as determined by the ASTM D 56 Flash Point by Tag Closed Cup Method. More preferably, the aromatic naphtha fraction or blend has a flash point between about 100 degrees F. (38 degrees C.) and about 200 degrees F. (93 degrees C.), and most preferably between about 100 and about 150 degrees F. (between about 38 and about 66 degrees C.). Certain substituted aromatics are useful for the naphtha blends including chlorinated or even brominated materials, however, unsubstituted (non-halogenated) materials are generally preferred.

The C₁ to C₅ alcohols useful in the paint removal compositions of the present invention preferably are monohydric alcohols, although polyhydric alcohols including ethylene and propylene glycols are useful as well. Isopropyl alcohol is most preferred, however, methyl and ethyl alcohols, and straight chain or branched propyl, butyl and amyl alcohols are also useful for preparing the paint cleaners of this invention. Mixtures of the aforedescribed alcohols may be utilized. In a preferred embodiment, one or more C₁ to C₅ alcohols having flash points between about 50 degrees F. (10 degrees C.) and about 59 degrees F. (15 degrees C.) are present in a total amount of from about 10 to about 30% by weight of the total composition, and most preferably between about 22 and about 28% by weight of the total composition. The use of methyl alcohol will significantly lower the resistivity of the resulting blend; if sufficient methyl alcohol is present in the blend, resistivities below about 1.5 Mohms and in the range of about 1.0 Mohms may be produced. Hence, the use of C₂-C₅ alcohols is preferred to maintain a higher level of electrical resistivity.

We have found, surprisingly, that mixtures of naphtha and alcohol as set forth above are especially useful for preparing a paint cleaner composition meeting automotive specifications for HAP (less than 4.5% by weight), flash point (at least about 60 degrees F.) and resistivity (greater than about 0.1 Mohms). Preferably the resistivity of the paint cleaner composition of this invention is about 2 Mohms or higher and most preferably is above about 4 Mohms. Advantageously, these substantially neutral and low cost compositions are quite effective for residual removal of solvent borne paint residues from paint lines, even though they contain relatively small amounts of more expensive or exotic auxiliary solvents such as ester and ketone solvents.

However, consistent with this invention, a wide range of known auxiliary solvents including ketones such as methyl isobutyl ketone, methyl ethyl ketone, and the like, as well as esters such as n-butyl acetate and the like can be incorporated in the compositions of the present invention. Because of the efficacy of the compositions of this invention, such auxiliary solvents are present in the composition at levels between about 1 and about 30% by weight and more preferably between about 10 and about 20% by weight of the total composition.

In the preferred method of purging solvent borne paint residues, the use of conventional added ingredients such as surfactants, thickeners, vapor suppression agents, colorants, corrosion inhibitors or buffers is substantially avoided mainly to avoid compatibility problems. Such materials are added in small amounts, e.g., less than 5% and most preferably less than 2% by weight as needed for other or special applications as may be appropriate.

The compositions of the invention are contacted with a paint residue (in the interior of or on a surface of paint delivery equipment such as a paint line, pump, tank, or sprayer, for example) for a time and at a temperature effective to loosen and remove the paint residue from the equipment. The paint residue may be, for example, a primer, base color paint, or clear coat and may be partially or fully dried. The paint removal performance of the compositions described herein is surprisingly quite effective at temperatures around room temperature (e.g., about 40 degrees F. to about 100 degrees F.). Heating the composition above room temperature thus is generally not necessary, although such heating will tend to accelerate the rate at which the paint residue is removed. The time required to remove the paint residue may also be reduced by agitating the composition while in contact with the paint residue, applying the composition at an elevated pressure against the paint residue, or by circulating or pumping the composition through the paint delivery equipment being cleaned. The used composition may be recycled or reused if desired, with conventional purification methods known in the art being employed if desired to remove contaminants such as the paint residue components.

### EXAMPLES

The percentages of the components used in the following examples are by weight based on the total weight of the resulting blend.

Blend 1 (In Accordance with the Invention)

In this example, 15% by weight n-butyl acetate, 25% by weight isopropyl alcohol, and 60% by weight Aromatic 100 Fluid (an aromatic naphtha supplied by ExxonMobil Chemical having a flash point of about 100 degrees F.) are combined to provide a blend having a flash point of 60 degrees F. The resistivity of the blend is 5 Mohms and the pH of the blend is about neutral. The HAP content is about 2.7%.

Comparative Blend 2 (Flash point of 63 degrees F.)

| | |
|---|---|
| Xylene | 55% |
| n-Butyl acetate | 10% |
| Methyl isobutyl ketone | 30% |
| Other solvents | 5% The other solvents include a mixture of |
| | Aromatic 100, isobutyl isobutyrate (IBIB), dibasic |
| | esters (DBE), Aromatic 150, and alcohol based |
| | solvents. |

The HAP content of this blend is between 85-90%.

Comporative Blend 3 (Flash point below 60 degrees F.)

| | |
|---|---|
| n-butyl acetate | 70% |
| isopropyl alcohol | 30% |

Comparative Blend 4 (Flash point below 60 degrees F.)

| | |
|---|---|
| n-butyl acetate | 50% |
| isopropyl alcohol | 15% |
| VM&P^{a} naphtha | 30% |
| Other solvents | 5% The other solvents include Aromatic 100, |
| | IBIB, DBE, Aromatic 150, alcohol based solvents, |
| | and methyl n-amyl ketone. |

^{a}Varnis Makers and Painters.

Behr's Efficiency Drop Test

R.D. Specialties wire rod #20 is used to apply 2.0 mL of wet paint to a glass plate. The paint film was allowed to flash dry for two minutes before performing the Behr purge method. The glass panel is then placed at a 45 degree angle. Ten drops of purge blend are dispensed from a pipette onto the panel at a drop rate of one drop per second. Each drop contacts the panel at the same point. Panels are rated according to the rating system shown in Table 1.

TABLE 1
Rating System

| Rating # | Description |
|---|---|
| 0 | does not work |
| 1 | not as good as the control |
| 2 | as good as the control |
| 3 | better than the control |
| 4 | far superior to the control |

TABLE 2
Performance Ratings at Two Minute Flash Time
All paints are BASF paints.

| Paint | Blend 1 | Blend 2 (Control) |
|---|---|---|
| RC65RW907 Inferno Red | 4 | 2 |
| R126RG901 Tinted Clearcoat | 4 | 2 |
| R165BW905 Patriot Blue | 4 | 2 |
| R126CG2023 Dura Clear 3 | 4 | 2 |
| Clearcoat | | |
| R164WW936 Stone White from | 4 | 2 |
| DaimlerChrysler Jefferson | | |
| Assembly Plant | | |
| NLOC21069 Shale Green | 4 | 2 |
| NLOC19935 Stone White | 4 | 2 |
| From Daimler Chrysler | | |
| Toledo Assembly Plant | | |
| U28AW213T Gray Primer | 4 | 2 |
| NLOC19934 | 4 | 2 |

Comparative Blends 2 to 4 are less effective than Blend 1 (prepared in accordance with this invention). Additionally, Blend 1 is far less costly to make than any of Blends 2 to 4.

While we described the invention in both general and specific terms, we intend that the invention is limited only by the claims, which appear below:

What is claimed is:

1. A composition useful for removal of paint residues from a substrate surface consisting essentially of: (a) about 40 to about 90% by weight, based on the total weight of the composition, of an aromatic naphtha fraction or blend having a flash point of at least about 100 degrees F., (b) about 10 to about 30% by weight, based on the total weight of said composition, of one or more C₁ to C₅ alcohols having a flash point less than about 59 degrees F., and (c) about 1 to about 30% by weight, based on the total weight of said composition, of at least one auxiliary solvent, said composition having a flash point of at least about 60 degrees F. and a solvent resistivity of at least about 0.1 Mohms.

2. The composition of claim 1 wherein the aromatic naphtha fraction or blend has a flash point between about 100 and about 200 degrees F.

3. The composition of claim 1, wherein said composition contains at least one C₃ monohydric alcohol.

4. The composition of claim 1, wherein said composition contains isopropyl alcohol.

5. The composition of claim 1 wherein said one or more C₁ to C₅ alcohols are selected from methyl alcohol, ethyl alcohol, propyl alcohols, butyl alcohols, amyl alcohols, or mixtures thereof.

6. The composition of claim 1 wherein at least one of said one or more C₁ to C₅ alcohols is a polyhydric alcohol.

7. The composition of claim 6 wherein the polyhydric alcohol is selected from ethylene glycol, propylene glycol, or mixtures thereof.

8. The composition of claim 1 wherein said auxiliary solvents are selected from esters, ketones, or mixtures thereof.

9. A composition useful for purging solvent borne paint residues which consists essentially of: (a) from about 50 to about 80% by weight, based on the total weight of the composition, of an aromatic naphtha fraction or blend having a flash point between about 100 and about 150 degrees F., (b) from about 10 to about 30% by weight, based on the total weight of the composition, of one or more C₂ to C₅ alcohols having a flash point between about 50 and about 59 degrees F., and (c) from about 10 to about 20% by weight, based on the total weight of the composition, of one or more auxiliary solvents selected from ketones, esters, and mixtures thereof, said composition having a flash point of at least 60 degrees F., a solvent resistivity of at least about 1.5 Mohms, and a substantially neutral pH.

10. The composition of claim 9 wherein said one or more C₂ to C₅ alcohols are present in an amount of from about 22 to about 28% by weight.

11. A method of removing a paint residue on a substrate surface which comprises contacting said residue with the composition of claim 1 for a time and at a temperature effective to loosen and remove said paint residue from said substrate surface.

12. A method of purging a solvent borne paint residue from a section of a paint delivery apparatus which comprises contacting said solvent borne paint residue with the composition of claim 9 for a time and at a temperature effective to purge said solvent borne paint residue from said section.

13. A method of making a composition useful for removal of paint residues which comprises:
(1) selecting an aromatic naphtha fraction or blend having a flash point above about 100 degrees F.;
(2) selecting one or more C₁ to C₅ alcohols having a flash point between about 50 to about 59 degrees F.;
(3) blending between about 40 to about 90% by weight, based on the total weight of the composition, of said aromatic naphtha fraction or blend, between about 10 to about 30% by weight, based on the total weight of the composition, of said one or more C₁ to C₅ alcohols, and between about 1 and about 30% by weight, based on the total weight of the composition, of one or more auxiliary solvents to obtain the composition, wherein said aromatic naptha fraction or blend, said one or more C₁ to C₅ alcohols, and said one or more auxiliary solvents and the relative proportions thereof are selected so as to impart to the composition a flash point of at least about 60 degrees F., a resistivity of about 0.15 Mohms or higher and a substantially neutral pH.

14. The method of claim 13 wherein the resistivity of the composition is at least about 2 Mohms.

15. The method of claim 13 wherein isopropyl alcohol is selected as at least one of said C₁ to C₅ alcohols.

16. The method of claim 13 wherein n-butyl acetate is selected as at least one of the auxiliary solvents.

17. A composition useful for removal of paint residues which consists essentially of: (a) about 55 to about 65% by weight, based on the total weight of said composition, of an aromatic naphtha fraction or blend having a flash point between about 100 and about 150 degrees F., (b) about 22 to about 28% by weight, based on the total weight of said composition, of isopropyl alcohol, and (c) about 10 to about 20% by weight, based on the total weight of said composition, of n-butyl acetate, said composition having an overall flash point of at least about 60 degrees F., a resistivity of at least about 4 Mohms and a substantially neutral pH.

18. The composition of claim 17 having a content of Hazardous Air Pollutants of no more than about 4.5% by weight.

19. A method of removing at least partially dried solvent borne paint residues from a section of a paint delivery apparatus, said method comprising contacting said solvent borne paint residues with the composition of claim 17 for a time and at a temperature effective to loosen and remove said solvent borne paint residues from said section.
